(19) United States
(12) Patent Application Publication
(10) Pub. No.: US 2004/0221153 A1
(43) Pub. Date: Nov. 4, 2004

(54) Apparatus and method of enciphering data packet of variable width

(75) Inventors: Chul-min Kim, Suwon-si (KR); Kyo-shin Choo, Yongin-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/772,422

(22) Filed: Feb. 6, 2004

(30) Foreign Application Priority Data
Feb. 6, 2003 (KR) 2003-7436

(51) Int. Cl. H04L 9/00

(52) U.S. Cl. 713/150

(57) ABSTRACT

An enciphering/deciphering apparatus and method are provided. The apparatus for enciphering data packets with a variable width comprises: a variable width-fixed width data packet conversion unit such that if a fixed width is a width of a data packet, which is processed in an enciphering process, and is a multiple of a variable width that is the width of an arbitrary data packet input from an arbitrary interface module, sequentially receiving the same number of variable width data packets as a combination value, which is obtained by dividing the fixed width by the variable width, and combining the same number of sequentially received variable width data packets as the combination value to generate a fixed width data packet and outputting the fixed width data packet; and an enciphering unit enciphering the outputted fixed width data packet to generate and to output a fixed width cipher data packet.

### CROSS-REFERENCE TO RELATED APPLICATION

This application claims the benefit of Korean Patent Application No. 2003-7436, filed Feb. 6, 2003, in the Korean Intellectual Property Office, the disclosure of which is incorporated herein by reference.

### BACKGROUND OF THE INVENTION

1. Field of the Invention

The present invention relates to an apparatus and method of enciphering/deciphering data complying with IP security protocol (IPsec).

2. Description of the Related Art

FIG. 1 is a diagram of a structure of a conventional IPsec enciphering/deciphering apparatus.

The conventional IPsec enciphering/deciphering apparatus comprises a memory controller 11, a packet control unit 12, an encapsulating security payload (ESP) memory 13, an ESP engine 14, an authentication header (AH) memory 15, an AH engine 16, and an output memory 17.

IPsec is a security protocol to achieve security communications over the Internet. More particularly, IPsec is for security of an IP layer and is a widely used technique in implementing a virtual private network (VPN). That is, IPsec is the security protocol to prevent wiretapping of data on the VPN. IPsec comprises an authentication header (AH) which provides an authentication operation to an entire data packet including an IP header; an encapsulating security payload (ESP) header which provides an enciphering/authentication operation to the payload excluding the IP header; and an Internet security association and key management protocol/internet key exchange (ISAKMP/IKE) which is in charge of security association (SA) negotiation and key management needed in an Internet security service.

IPsec is embedded in a user terminal so that data is exchangeable between only predetermined terminals. IPsec standard draft (RFC2401-2410) does not define enciphering/deciphering or authentication methods in one way, but defines a frame to control a variety of ways of enciphering/deciphering or authentication methods. This frame is referred to as security association (SA). If operations to perform a variety of ways of enciphering/deciphering or authentication methods are implemented by hardware (i.e., IPsec on chip), resource and computation time may be substantially reduced.

The IPsec enciphering/deciphering apparatus shown in FIG. 1 is the IPsec implemented by hardware. The memory controller 11 interlocks an external interface module to the packet processor (i.e., ESP engine 14), the internal memory (ESP memory) 13, the AH memory 15, and the output memory 17. The packet processor 14 interlocks the memory controller 11 to the IPsec engine (ESP engine) 14 and the AH engine 16. The IPsec engine (ESP engine) 14 and the AH engine 16 do not receive data packets directly from the external interface module. By the memory controller 11, which is internal, the data packets are stored in the ESP memory 13 and the AH memory 15 and then the IPsec engine (ESP engine) 14 and the AH engine 16 operate. The output memory 17 stores data output from the IPsec engine (ESP engine) 14 and the AH engine 16.

In the hardware implementation described above, interface with the external interface module is important together with internal operations. Since the external interface module is predetermined, a number of I/O ports in the IPsec chip is predetermined. Accordingly, the IPsec enciphering/deciphering apparatus shown in FIG. 1 receives a fixed width data packet which has a fixed width (for example, a 16-bit data packet) from an internal system, enciphers the fixed width data packet, and outputs a fixed width cipher data packet. Further, the conventional enciphering/deciphering apparatus receives a fixed width cipher data packet from the network, deciphers the fixed width cipher data packet and outputs a fixed width data packet.

Conventionally, when an external interface module is changed, the number of I/O ports changes such that the memory controller should be redesigned. Accordingly, a problem exists that the memory controller should be redesigned from register transfer language (RTL) code, causing inconveniences and wasted time. In particular, in an IPv6 environment, unlike in an IPv4 environment, an external interface module will be frequently changed due to the characteristic of the IPv6 in order to use the IPsec apparatus in a variety of platforms (for example, all home appliances in a house).

### SUMMARY OF THE INVENTION

The present invention provides an apparatus and method by which when an external interface module connected to an IPsec chip is changed, data packets of variable widths output from an arbitrary external interface module are encipherable and variable width cipher data packets are decipherable.

Additional aspects and/or advantages of the invention will be set forth in part in the description which follows and, in part, will be obvious from the description, or may be learned by practice of the invention.

According to an aspect of the present invention, there is provided an apparatus for enciphering a variable width data packet comprising: a variable width-fixed width data packet conversion unit which, if a fixed width is a multiple of a variable width, sequentially receives a number of variable width data packets, the number of which being the same as that of a combination value, and combines the number of sequentially input variable width data packets received to generate a fixed width data packet and outputs the fixed width data packet; and an enciphering unit enciphers the fixed width data packet output from the variable width-fixed width data packet conversion unit to generate a fixed width cipher data packet, and outputs the fixed width cipher data packet. The fixed width is a width of a data packet, which is processed in an enciphering process, and the variable width is a width of an arbitrary data packet input from an arbitrary interface module. The combination value is obtained by dividing the fixed width by the variable width.

According to an aspect of the present invention, there is provided an apparatus for deciphering a variable width cipher data packet comprising: a variable width-fixed width cipher data packet conversion unit which, if a fixed width is a multiple of a variable width, sequentially receives a number of variable width cipher data packets, the number of which being the same as that of a combination value, combines the number of sequentially input variable width cipher data packets received to generate a fixed width cipher data packet and outputs the fixed width cipher data packet; and a deciphering unit deciphers the fixed width cipher data packet output from the variable width-fixed width cipher data packet conversion unit to generate a fixed width data packet and outputs the fixed width data packet. The fixed width is a width of a cipher data packet to be processed in a deciphering process and the variable width is a width of an arbitrary cipher data packet input by an arbitrary interface module. The combination value is obtained by dividing the fixed width by the variable width.

According to another aspect of the present invention, there is provided a variable width-fixed width data packet conversion apparatus comprising: a variable width data packet input/output unit which, if a fixed width is a multiple of a variable width, sequentially receives a number of variable width first data packets, the number of which being the same as that of a combination value; a variable width data packet combination unit combines a number of variable width first data packets received sequentially input to the variable width data packet input/output unit to generate a fixed width first data packet; and a fixed width data packet input/output unit outputs the fixed width first data packet generated in the variable width data packet combination unit. The fixed width is a width of a data packet processed inside a system and the variable width is a width of an arbitrary data packet input from outside of the system. The combination value is obtained by dividing the fixed width by the variable width.

According to another aspect, a method of enciphering a variable width data packet is provided comprising: if a fixed width is a multiple of a variable width, sequentially receiving a number of variable width data packets, the number of which being the same as that of a combination value, and combining the number of sequentially input variable width data packets received to generate and to output a fixed width data packet; and enciphering the fixed width data packet to generate and output a fixed width cipher data packet. The fixed width is a width of a data packet processed in an enciphering process and the variable width is a width of an arbitrary data packet input from an arbitrary interface module. The combination value is obtained by dividing the fixed width by the variable width.

According to another aspect, a method of deciphering a variable width cipher data packet is provided comprising: if a fixed width is a multiple of a variable width, sequentially receiving a number of variable width cipher data packets, the number of which being the same as that of a combination value, combining the number of sequentially input variable width cipher data packets received to generate and output a fixed width cipher data packet; and deciphering the fixed width cipher data packet to generate and output a fixed width data packet. The fixed width is a width of a cipher data packet processed in a deciphering process and the variable width is a width of an arbitrary cipher data packet input by an arbitrary interface module. The combination value is obtained by dividing the fixed width by the variable width.

According to another aspect, a variable width-fixed width data packet conversion method is provided comprising: if a fixed width is a multiple of a variable width, sequentially receiving a number of variable width first data packets, the number of which being the same as that of a combination value; combining the number of sequentially input variable width first data packets received to generate the fixed width first data packet; and outputting the generated fixed width first data packet. The fixed width is a width of a data packet processed inside a system and the variable width is a width of an arbitrary data packet input from outside of the system. The combination value is obtained by dividing the fixed width by the variable width.

### BRIEF DESCRIPTION OF THE DRAWINGS

These and/or other aspects and advantages of the invention will become apparent and more readily appreciated from the following description of the embodiments taken in conjunction with the accompanying drawings in which:

FIG. 1 is a diagram of a structure of the conventional IPsec enciphering/deciphering apparatus;

FIG. 2 is a diagram of a structure of a variable width data packet enciphering apparatus according to a first embodiment of the present invention;

FIG. 3 is a diagram of a structure of an enciphering unit of FIG. 2;

FIG. 4 is a diagram of a structure of a variable width cipher data packet deciphering apparatus according to a second embodiment of the present invention;

FIG. 5 is a diagram of a structure of a deciphering unit of FIG. 4;

FIG. 6 is a diagram of a structure of an IPsec enciphering/deciphering apparatus according to a third embodiment of the present invention;

FIG. 7 is a diagram of a structure of a variable width-fixed width data packet conversion apparatus according to a fourth embodiment of the present invention;

FIG. 8 is a diagram of a structure of a variable width data packet combination unit of FIG. 7;

FIG. 9 is a diagram of a structure of a fixed width data packet combination unit of FIG. 7;

FIG. 10 is a flowchart of operations performed by a variable width data packet enciphering method according to a fifth embodiment of the present invention;

FIG. 11 is a flowchart of the operations 104 and 109 of FIG. 10;

FIG. 12 is a flowchart of operations performed by a variable width cipher data packet deciphering method according to a sixth embodiment of the present invention;

FIG. 13 is a flowchart of the operations 124 and 129 of FIG. 12;

FIG. 14 is a flowchart of operations performed by a variable width-fixed width data packet conversion method according to a seventh embodiment of the present invention;

FIG. 15 is a flowchart of the operation 143 of FIG. 14; and

FIG. 16 is a detailed flowchart of the operation 1412 of FIG. 14.

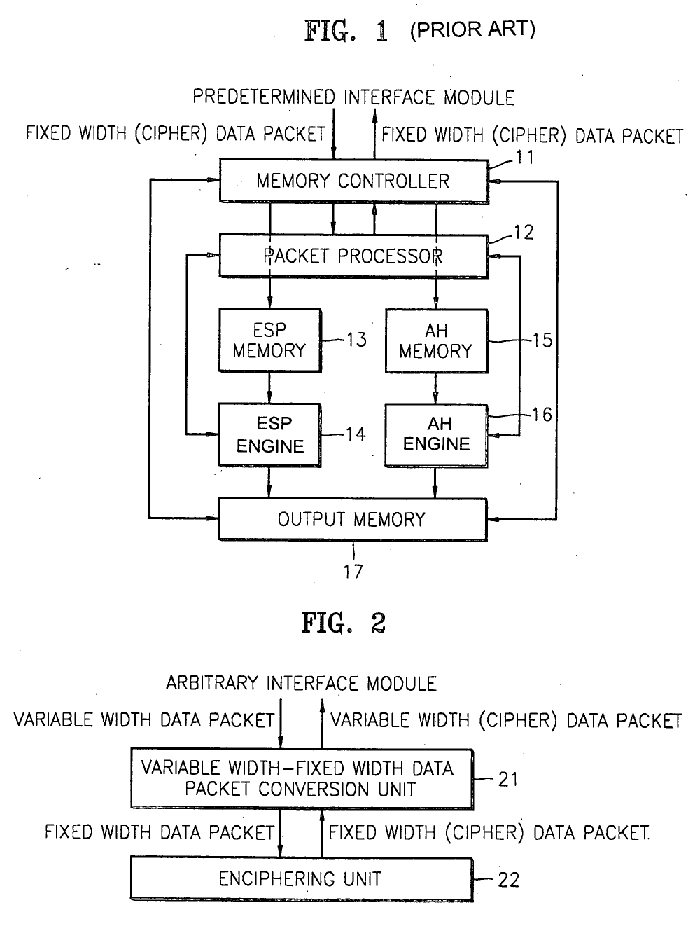

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

Referring to FIG. 2, a variable width data packet enciphering apparatus according to a first embodiment of the present invention comprises a variable width-fixed width data packet conversion unit 21 and an enciphering unit 22.

If a fixed width is a multiple of a variable width, the variable width-fixed width data packet conversion unit 21 sequentially receives a number of variable width data packets, the number of which being the same as that of a combination value, and by combining the number of sequentially input variable width data packets received, generates and outputs a fixed width data packet. The fixed width is a width of a data packet processed in an enciphering process and the variable width is a width of an arbitrary data packet input from an arbitrary interface module. The combination value is obtained by dividing the fixed width by the variable width.

For example, if the width of the arbitrary data packet (a data packet going outward, i.e., to be enciphered), which is input through the arbitrary interface module, is 16 bits and the width of the data packet, which is processed in the enciphering process of a variable width data packet enciphering apparatus, is 32 bits (i.e., if the variable width is 16 bits and the fixed width is 32 bits) a variable width data packet enciphering apparatus can process only a data packet of a 32-bit width and, otherwise, the 16-bit data packet input from an internal system cannot be enciphered. Accordingly, the variable width-fixed width data packet conversion unit 21 sequentially receives two 16-bit data packets, combines the two 16-bit data packets received, generates a 32-bit data packet, and enciphers the combined 32-bit data packet. Thus, a combination value of the combined 32-bit data packet is 2. If the width of a data packet input from the external interface module is 8 bits, four packets can be sequentially received and processed together. In this case the combination value is 4. Since the variable width-fixed width data packet conversion unit 21, if enciphering in the enciphering unit 22 is completed, outputs data packets one by one, the variable width-fixed width data packet conversion unit 21 plays roles of both the conventional memory controller and packet processor.

The enciphering unit 22 enciphers a fixed width data packet output from the variable width-fixed width data packet conversion unit 21, generates a fixed width cipher data packet and outputs the fixed width cipher data packet. The enciphering unit 22 comprises an ESP memory, an AH memory, and a memory storing output data of an IPsec engine (i.e., enciphered data packets). Since the width of data input to or out from a memory is fixed, the enciphering unit 22 can process only one width of data. Thus, the enciphering unit 22 can encipher only a data packet with a fixed width. Accordingly, to encipher data packets with a variety of data widths input from an arbitrary interface module, the variable width-fixed width data packet conversion unit 21, which converts a data packet of a variable width into a data packet of a fixed width, may be disposed before the enciphering unit 22.

If enciphering is completed in the enciphering unit 22, the variable width-fixed width data packet conversion unit 21 divides a fixed width cipher data packet output from the enciphering unit 22 by the combination value, generates the same number of variable width cipher data packets as that of the combination value, and sequentially outputs the same number of generated variable width cipher data packets as that of the combination value. In the above example, having two 16-bit data packets combined into a 32-bit data packet, the variable width-fixed width data packet conversion unit 21 divides the enciphered 32-bit data packet by the number of the combination value (i.e., two). This is because the number of I/O ports connected to the external interface module is 16 and only a 16-bit data packet may be transmitted to the external interface module through this I/O ports.

If a variable width is a multiple of a fixed width, the variable width-fixed width data packet conversion unit 21 receives a variable width data packet, divides the received variable width data packet into a number of fixed width data packets, the number being the same as that of a separation value, generates the number of fixed width data packets received, and sequentially outputs the generated fixed width data packets. The separation value is obtained by dividing the variable width by the fixed width.

For example, if the variable width is 32 bits and the fixed width is 16 bits, a 32-bit data packet input from the external interface module may be divided, unlike that of the above case in which the variable width is 16 bits and the fixed width is 32 bits. The variable width-fixed width data packet conversion unit 21 may divide the 32-bit data packet by a separation value that is obtained by dividing the variable width by the fixed width (i.e., by dividing by two), and then sequentially outputs the fixed width data packets to the enciphering unit 22.

If enciphering is completed in the enciphering unit 22, the variable width-fixed width data packet conversion unit 21 sequentially receives a number of fixed width cipher data packets output from the enciphering unit 22, the number of which being the same as that of the separation value, combines the number of fixed width cipher data packets received, generates a variable width cipher data packet and outputs the variable width cipher data packet. In the above example, the variable width-fixed width data packet conversion unit 21 sequentially receives two enciphered 16-bit data packets from the enciphering unit 22, combines the two enciphered 16-bit data packets sequentially received, generates a 32-bit cipher data packet, and outputs the generated 32-bit cipher data packet to the external interface module.

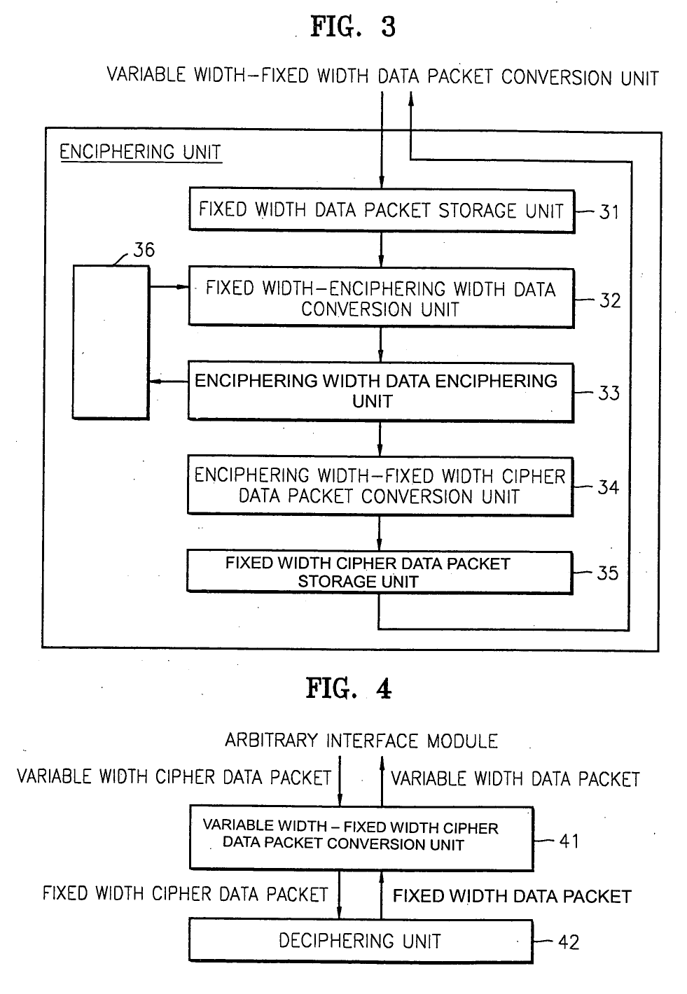

FIG. 3 is a diagram of a structure of the enciphering unit 22 of FIG. 2.

The enciphering unit 22 comprises a fixed width data packet storage unit 31, a fixed width-enciphering width data conversion unit 32, an enciphering width data enciphering unit 33, an enciphering width-fixed width cipher data packet conversion unit 34, a fixed width cipher data packet storage unit 35, and an enciphering control unit 36.

The fixed width data packet storage unit 31 stores a fixed width data packet generated by the variable width-fixed width data packet conversion unit 21 of FIG. 2. According to the IPsec standard draft, after a data packet is stored in an ESP memory and an AH memory, the data packet is output to both an ESP engine and an AH engine which then perform enciphering or deciphering of the data packet. The fixed width data packet storage unit 31 plays the roles of the ESP memory and the AH memory.

The fixed width-enciphering width data conversion unit 32 converts a fixed width data packet stored in the fixed width data packet storage unit 31 into enciphering width data. In the case of an ESP engine using data encryption standard (DES)-cipher block chaining (CBC) algorithm, 64-bit data is input and enciphered, and 64-bit cipher data is output. DES-CBC is a secret key algorithm for security. In the case of an IPv6 data packet, a maximum available data amount is 1500 bytes, and the fixed width-enciphering width data conversion unit 32 splits a fixed width data packet stored in the fixed width data packet storage unit 31, generates 64-bit data, and sends the generated 64-bit data to an ESP engine using the DES-CBC algorithm. At this time, the ESP engine enciphers only user data stored in a payload field in a fixed width data packet stored in the fixed width data packet storage unit 31.

In the case of the AH engine using a hash message authentication code (HMAC)-message digest function 95 (MD5) algorithm, 32-bit data is input and enciphered and 32-bit cipher data is output. HMAC-MD5 is a secret key algorithm providing authentication. The fixed width-enciphering width data conversion unit 32 splits a fixed width data packet stored in the fixed width data packet storage unit 31, generates 32-bit data, and sends the generated 32-bit data to the AH engine using the HMAC-MD5 algorithm. At this time, the AH engine is in charge of authentication for the entire fixed width data packet stored in the fixed width data packet storage unit 31 and therefore generates a hash code providing authentication for an entire fixed width data packet.

The enciphering width data enciphering unit 33 enciphers enciphering width data converted in the fixed width-enciphering width data conversion unit 32, and generates enciphering width cipher data. In an IP environment, the enciphering width data enciphering unit 33 may be the ESP engine or the AH engine. Here, the ESP engine enciphers a payload part of a data packet and the AH engine generates an authentication code of an entire data packet. If enciphering width cipher data is generated, the enciphering width data enciphering unit 33 generates and outputs an enciphering completion signal. If enciphering is completed, the enciphering completion signal is generated and output to indicate that the enciphering width data enciphering unit 33 is ready to encipher another data packet.

The enciphering width-fixed width cipher data packet conversion unit 34 converts enciphering width cipher data generated in the enciphering width data enciphering unit 33 into a fixed width cipher data packet. If the enciphering width data enciphering unit 33 is the ESP engine using the DEC-CBC algorithm, the enciphering width-fixed width cipher data packet conversion unit 34 combines 64-bit cipher data and generates a fixed width cipher data packet. If the enciphering width data enciphering unit 33 is the AH engine using the HMAC-MD5 algorithm, the enciphering width-fixed width cipher data packet conversion unit 34 combines 32-bit authentication codes and generates a fixed width cipher data packet to which a 128-bit hash code is attached.

The fixed width cipher data packet storage unit 35 stores a fixed width cipher data packet which is converted in the enciphering width-fixed width cipher data packet conversion unit 34. The fixed width cipher data packet storage unit 35 temporarily stores a fixed width cipher data packet, and sends the stored fixed width cipher data packet to the variable width-fixed width data packet conversion unit 21 of FIG. 2.

If an enciphering completion signal output from the enciphering width data enciphering unit 33 is received, the enciphering control unit 36 generates and outputs a fixed width-enciphering width conversion signal. Thus, the fixed width-enciphering width conversion signal is sent to the fixed width-enciphering width data conversion unit 32 to indicate that data to be enciphered may be input to the enciphering width data enciphering unit 33 which completes the enciphering process. At this time, if the fixed width-enciphering width conversion signal output from the enciphering control unit 36 is received by the fixed width-enciphering width data conversion unit 32, the fixed width-enciphering width data conversion unit 32 converts a fixed width data packet stored in the fixed width data packet storage unit 31 into enciphering width data.

FIG. 4 is a diagram of a structure of a variable width cipher data packet deciphering apparatus according to a second embodiment of the present invention.

The variable width cipher data packet deciphering apparatus comprises a variable width-fixed width cipher data packet conversion unit 41 and a deciphering unit 42.

If a fixed width is a multiple of a variable width, the variable width-fixed width cipher data packet conversion unit 41 sequentially receives a number of variable width cipher data packets, the number of which being the same as that of a combination value, combines the number of sequentially input variable width cipher data packets received, generates a fixed width cipher data packet and outputs the generated fixed width cipher data packet. The fixed width is a width of a cipher data packet to be processed in a deciphering process and the variable width is a width of an arbitrary cipher data packet input by an arbitrary interface module. The combination value is obtained by dividing the fixed width by the variable width.

For example, if the width of the arbitrary cipher data packet input by the arbitrary interface module (a cipher data packet input from the outside) is 16 bits and the width of a cipher data packet to be processed in the deciphering process of the variable width cipher data packet deciphering apparatus is 32 bits (i.e., if the variable width is 16 bits and the fixed width is 32 bits), the variable width cipher data packet deciphering apparatus can process only a data packet of a 32-bit width and, otherwise, cannot decipher the 16-bit cipher data packet input from the outside. Accordingly, the variable width-fixed width cipher data packet conversion unit 41 sequentially receives two 16-bit cipher data packets, combines the two 16-bit cipher data packets received, generates a combined 32-bit cipher data packet, and deciphers the combined 32-bit cipher data packet.

The deciphering unit 42 deciphers the fixed width cipher data packet output from the variable width-fixed width cipher data packet conversion unit 41, generates a fixed width data packet and outputs the generated fixed width data packet.

If the deciphering is completed in the deciphering unit 42, the variable width-fixed width cipher data packet conversion unit 41 divides a fixed width data packet output from the deciphering unit 42 by the combination value, generates a number of variable width data packets, the number of which being the same as that of the combination value, and sequentially outputs the generated variable width data packets. In the above example having the combined 32-bit cipher data packet, the variable width-fixed width cipher data packet conversion unit 41 may divide the deciphered 32-bit data packet by the combination value (i.e., two). This is because a number of I/O ports connected to the external interface module is 16 and only a 16-bit data packet is transmittable to the external interface module through this I/O ports.

If a variable width is a multiple of a fixed width, the variable width-fixed width cipher data packet conversion unit 41 receives a variable width cipher data packet, divides the received variable width cipher data packet by a separation value, generates a number of fixed width cipher data packets, the number of which being the same as that of the separation value, and sequentially outputs the generated fixed width cipher data packets. The separation value is obtained by dividing the variable width by the fixed width.

For example, if the variable width is 32 bits and the fixed width is 16 bits, a 32-bit cipher data packet input from the external interface module may be divided, unlike that the above case in which the variable width is 16 bits and the fixed width is 32 bits. The variable width-fixed width cipher data packet conversion unit 41 may divide the 32-bit cipher data packet by the separation value that is obtained by dividing the variable width by the fixed width(i.e., by dividing by two) and then sequentially outputs the fixed width cipher data packets to the deciphering unit 42.

If deciphering is completed in the deciphering unit 42, the variable width-fixed width cipher data packet conversion unit 41 receives the number of fixed width data packets output from the deciphering unit 42, combines the number of sequentially received fixed width data packet, generates a variable width data packet and outputs the generated variable width data packet. In the above example, the variable width-fixed width cipher data packet conversion unit 41 sequentially receives two deciphered 16-bit data packets, combines the two deciphered 16-bit data packets sequentially input, generates a 32-bit data packet, and outputs the generated 32-bit data packet to the external interface module.

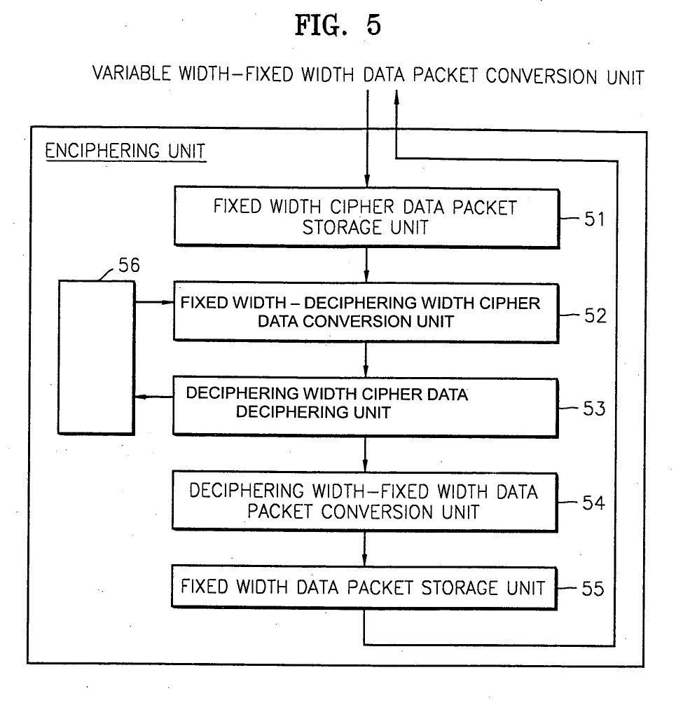

FIG. 5 is a diagram of a structure of the deciphering unit 42 of FIG. 4.

The deciphering unit 42 comprises a fixed width cipher data packet storage unit 51, a fixed width-deciphering width cipher data packet conversion unit 52, a deciphering width cipher data deciphering unit 53, a deciphering width-fixed width data packet conversion unit 54, a fixed width data packet storage unit 55, and a deciphering control unit 56.

The fixed width cipher data packet storage unit 51 stores a fixed width cipher data packet generated by the variable width-fixed width cipher data packet conversion unit 41 of FIG. 4. According to the IPsec standard draft, after a data packet is stored in an ESP memory and an AH memory, the data packet is output to both an ESP engine and an AH engine which then perform enciphering or deciphering of the packet. The fixed width cipher data packet storage unit 51 plays the roles of the ESP memory and the AH memory.

The fixed width-deciphering width cipher data conversion unit 52 converts a fixed width cipher data packet stored in the fixed width cipher data packet storage unit 51 into deciphering width cipher data. In the case of the ESP engine using the DES-CBC algorithm, 64-bit cipher data is received and deciphered and 64-bit data is output. The fixed width-deciphering width cipher data conversion unit 52 splits a fixed width cipher data packet stored in the fixed width cipher data packet storage unit 51, generates 64-bit data, and sends the generated 64-bit data to the ESP engine using the DES-CBC algorithm. At this time, the ESP engine deciphers only user data stored in a payload field in the fixed width cipher data packet stored in the fixed width cipher data packet storage unit 51. In the case of the AH engine using an HMAC-MD5 algorithm, 32-bit cipher data is received and deciphered and 32-bit data is output. The fixed width-deciphering width cipher data conversion unit 52 splits the fixed width cipher data packet stored in the fixed width cipher data packet storage unit 51, generates 32-bit data, and sends the generated 32-bit data to the AH engine using the HMAC-MD5 algorithm. At this time, the AH engine is in charge of authentication of an entire fixed width cipher data packet stored in the fixed width cipher data packet storage unit 51 and therefore determines whether or not to authenticate the entire fixed width cipher data packet.

The deciphering width cipher data deciphering unit 53 deciphers deciphering width cipher data converted in the fixed width-deciphering width data conversion unit 52, and generates deciphering width data. In the IP environment, the deciphering width cipher data deciphering unit 53 may be an ESP engine or an AH engine. Here, the ESP engine deciphers a payload part of a data packet and the AH engine determines whether or not to authenticate an entire data packet. If deciphering width data is generated, the deciphering width cipher data deciphering unit 53 generates and outputs a deciphering completion signal. If deciphering is completed, the deciphering completion signal is generated and output to indicate that the deciphering width cipher data deciphering unit 53 is ready to decipher another data packet.

The deciphering width-fixed width data packet conversion unit 54 converts deciphering width data generated in the deciphering width cipher data deciphering unit 53 into a fixed width data packet. If the deciphering width cipher data deciphering unit 53 is the ESP engine using the DES-CBC algorithm, the deciphering width-fixed width data packet conversion unit 54 combines 64-bit data and generates a fixed width data packet. If the deciphering width cipher data deciphering unit 53 is the AH engine using the HMAC-MD5 algorithm, the deciphering width-fixed width data packet conversion unit 54 combines 32-bit authentication codes, generate a 128-bit authentication code, and determines whether or not to authenticate the fixed width data packet.

The fixed width data packet storage unit 55 stores the fixed width data packet converted in the deciphering width-fixed width data packet conversion unit 54. The fixed width data packet storage unit 55 temporarily stores the fixed width data packet and sends the fixed width data packet to the variable width-fixed width cipher data packet conversion unit 41 of FIG. 4.

If a deciphering completion signal output from the deciphering width cipher data deciphering unit 53 is received, the deciphering control unit 56 generates and outputs a fixed width-deciphering width conversion signal. Thus, to indicate that data to be deciphered may be input to the deciphering width cipher data deciphering unit 53, which has completed a deciphering process, the fixed width-deciphering width conversion signal is sent to the fixed width-deciphering width cipher data conversion unit 52. At this time, if the fixed width-deciphering width conversion signal output from the deciphering control unit 56 is received by the fixed width deciphering width cipher data conversion unit 52, the fixed width-deciphering width cipher data conversion unit 52 converts a fixed width cipher data packet stored in the fixed width cipher data packet storage unit 51 into deciphering width cipher data.

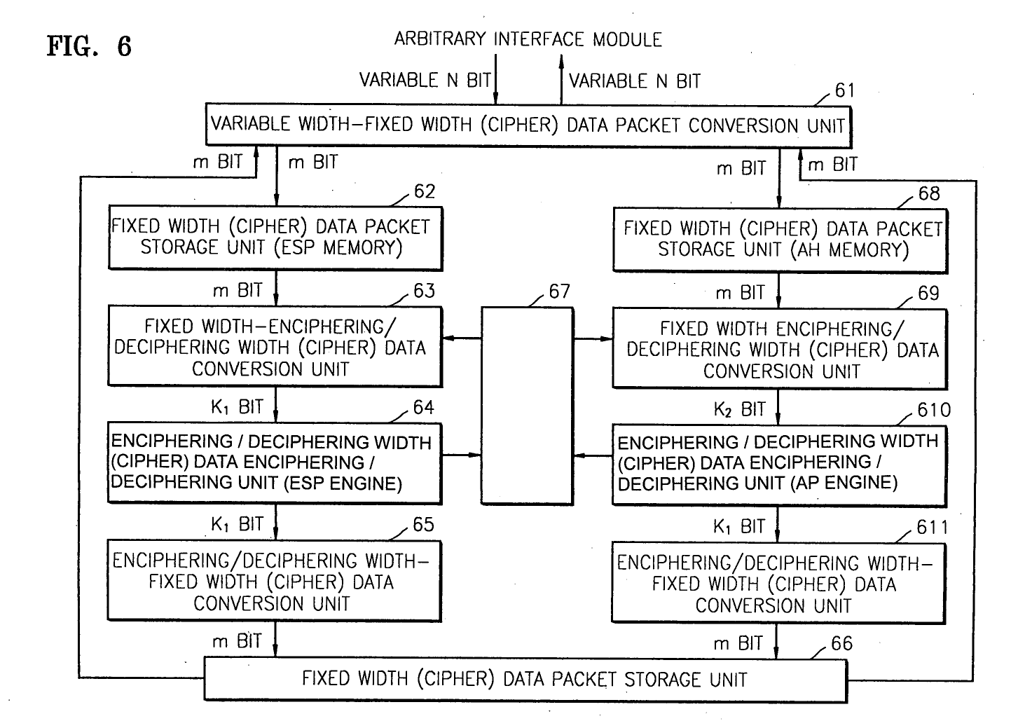

FIG. 6 is a diagram of an IPsec enciphering/deciphering apparatus according to a third embodiment of the present invention.

The IPsec enciphering/deciphering apparatus comprises a variable width-fixed width (cipher) data packet conversion unit 61, fixed width (cipher) data packet storage units 62 and 68, fixed width enciphering/deciphering width (cipher) data conversion units 63 and 69, enciphering/deciphering width (cipher) data enciphering/deciphering units 64 and 610, enciphering/deciphering width-fixed width (cipher) data packet conversion unit 65 and 611, an enciphering/deciphering width-fixed width (cipher) data packet storage unit 66 and an enciphering/deciphering control unit 67.

Referring to FIG. 6, the variable width-fixed width (cipher) data packet conversion unit 61 receives a variable N-bit data packet or a variable N-bit cipher data packet from the external interface module, converts the variable N-bit data packets of the variable N-bit cipher data packet into fixed m-bit data packets and stores the converted fixed m-bit data packets in the fixed width (cipher) data packet storage units 62 and 68. The fixed width (cipher) data packet storage units (i.e., memories) 62 and 68 correspond to an ESP memory and an AH memory, respectively. The fixed width-enciphering/deciphering width (cipher) data conversion units 63 and 69 convert the stored data packet or cipher data packet into k1-bit data and k2-bit data, respectively. The k1 bits are an amount that is processable in the enciphering/deciphering width (cipher) data enciphering/deciphering unit 64 (i.e., the ESP engine), and the k2 bits are an amount that is processable in the enciphering/deciphering width (cipher) data enciphering/deciphering unit 610 (i.e., the AH engine). The enciphering/deciphering width (cipher) data enciphering/deciphering units 64 and 610 (i.e., the ESP engine and the AH engine) encipher or decipher k1-bit data and k2-bit data, respectively. The enciphering/deciphering width-fixed width (cipher) data packet conversion units 65 and 611 convert data enciphered or deciphered in the enciphering/deciphering width (cipher) data enciphering/deciphering units 64 and 610, respectively, into m-bit cipher data packets or m-bit data packets. If m-bit cipher data packets or m-bit data packets are generated through this process, the m-bit cipher data packets or m-bit data packets are stored in the fixed width (cipher) data packet storage unit 66. The m-bit cipher data packets or m-bit data packets stored in the fixed width (cipher) data packet storage unit 66 are converted into a variable N-bit cipher data packet or a variable N-bit data packet and output to the external interface module. If the enciphering/deciphering width (cipher) data enciphering/deciphering units 64 and 610 (i.e., the ESP engine and the AH engine) complete enciphering or deciphering, the enciphering/deciphering control unit 67 controls the fixed width enciphering/deciphering width (cipher) data conversion units 63 and 69 so that data desired to be enciphered or deciphered is inputtable from the fixed width enciphering/deciphering width (cipher) data conversion units 63 and 69, directly to the enciphering/deciphering width (cipher) data enciphering/deciphering units 64 and 610, respectively.

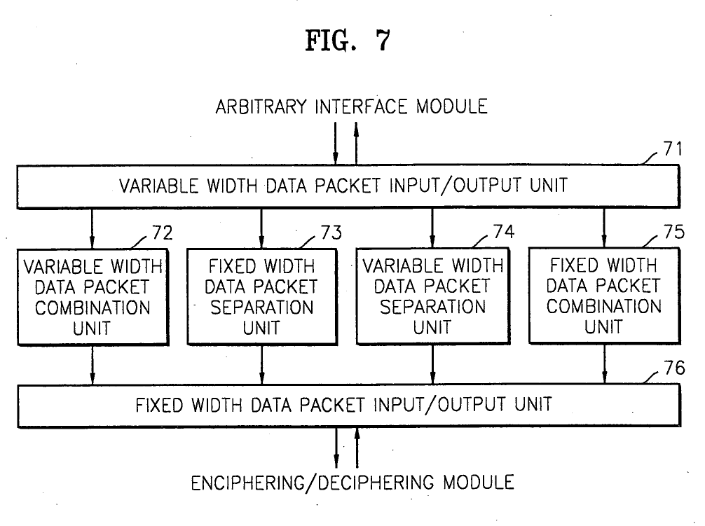

FIG. 7 is a diagram of a structure of a variable width-fixed width data packet conversion apparatus according to a fourth embodiment of the present invention.

The variable width-fixed width data packet conversion apparatus comprises a variable width data packet input/output unit 71, a variable width data packet combination unit 72, a fixed width data packet separation unit 73, a variable width data packet separation unit 74, a fixed width data packet combination unit 75 and a fixed width data packet input/output unit 76.

If a fixed width that is a width of a data packet processed inside a system is a multiple of a variable width that is a width of an arbitrary data packet input from an outside of the system, the variable width data packet input/output unit 71 sequentially receives a number of variable width first data packets, the number of which being the same as that of a combination value. The combination value is obtained by dividing the fixed width by the variable width. The variable width-fixed width data packet conversion apparatus used in the variable width data packet enciphering/deciphering apparatus is useable in a variety of apparatuses in addition to the enciphering/deciphering apparatus. In an IPv6 environment, unlike an IPv4 environment, the external interface module will be frequently changed due to a characteristic of the IPv6 in order to use the enciphering/deciphering apparatus in a variety of platforms, for example, all home appliances in a house.

Accordingly, the variable width-fixed width data packet conversion apparatus may be used in all peripheral apparatuses that need the external interface module. If a fixed width that is the width of a data packet processed inside the system is a multiple of the variable width that is the width of an arbitrary data packet input from the outside of the system, to generate a first data packet of the fixed width the variable width data packet input/output unit 71 sequentially receives the number of variable width first data packets, the number of which being the same as that of a combination value, that is obtained by dividing the fixed width by the variable width.

The variable width data packet combination unit 72 combines the number of variable width first data packets received, the variable width first data packets being sequentially input to the variable width data packet input/output unit 71, and generates a fixed width first data packet. The fixed width data packet input/output unit 76 outputs the fixed width first data packet generated in the variable width data packet combination unit 72.

The fixed width first data output from the fixed width data packet input/output unit 76 is input to a module mounting a variable width-fixed width data packet conversion apparatus, for example, an enciphering module or a deciphering module, and again from the module, fixed width second data is output. If the module mounting the variable width-fixed width data packet conversion apparatus is the enciphering module, the second data packet is one that is enciphered from the first data packet, and if the module is the deciphering module, the second data packet is one that is deciphered from the first data packet.

The fixed width data packet input/output unit 76 receives a fixed width second data packet from the module mounting the variable width-fixed width data packet conversion apparatus. The fixed width data packet separation unit 73 divides the fixed width second data packet input to the fixed width data packet input/output unit 76 into a number of variable width second data packets, the number of which is the same as that of a combination value, and generates the number of divided variable width second data packets. If variable width data is converted into a fixed width data packet to be processed in the module mounting a variable width-fixed width data packet conversion apparatus and the processing is finished, to convert again into a variable width data packet that is processable in the external module, a fixed width data packet is divided into a number of variable width data packets, the number of which being the same as that of the combination value. The variable width data packet input/output unit 71 sequentially outputs the number of divided variable width second data packets, which are the packets generated in the fixed width data packet separation unit 73.

If a variable width is a multiple of a fixed width, the variable width data packet input/output unit 71 receives one variable width first data packet. The variable width data packet separation unit 74 divides the variable width first data packet input to the variable width data packet input/output unit 71 by a separation value that is obtained by dividing the variable width by the fixed width, and generates the number of fixed width first data packets, the number of which being the same as that of the separation value. The variable width data packet separation unit 74 divides one variable width data packet by a separation value that is obtained by dividing the variable width by the fixed width, and generates fixed width first data packets that are processable in the enciphering module or the deciphering module. The fixed width data packet input/output unit 76 sequentially outputs the number of fixed width first data packets generated, which are the packets generated in the variable width data packet separation unit 74. Since the enciphering module or the deciphering module processes data in units of packets, in general, immediately after the enciphering module or the deciphering module processes one packet, the variable width-fixed width data packet conversion apparatus may input another to the enciphering or deciphering module. In the conventional art, a packet processor is separately disposed and in charge of adjusting the packet flow. However, in the present invention, the variable width-fixed width data packet conversion apparatus also plays the role of a packet processor.

As described above, the fixed width first data output from the variable width data packet input/output unit 76 is input to a module mounting the variable width-fixed width data packet conversion apparatus, for example, the enciphering module or the deciphering module, and again from the module, fixed width second data is output. If a variable width is a multiple of a fixed width, the fixed width data packet input/output unit 76 sequentially receives the number of fixed width second data packets, the number of which being the same as that of a separation value, that is obtained by dividing the variable width by the fixed width. This is a case where the variable width that is the width of an arbitrary data packet input from the outside is a multiple of the fixed width that is the width of a data packet processed inside the system. To generate one variable width second data packet, the fixed width data packet input/output unit 76 sequentially receives the number of fixed width second data packets, the number of which being the same as that of the separation value.

The fixed width data packet combination unit 75 combines the same number of fixed width second data packets as the separation value, which are the packets input to the fixed width data packet input/output unit 76, and generates a variable width second data packet. The variable width data packet input/output unit 71 outputs the variable width second data packet generated in the fixed width data packet combination unit 75.

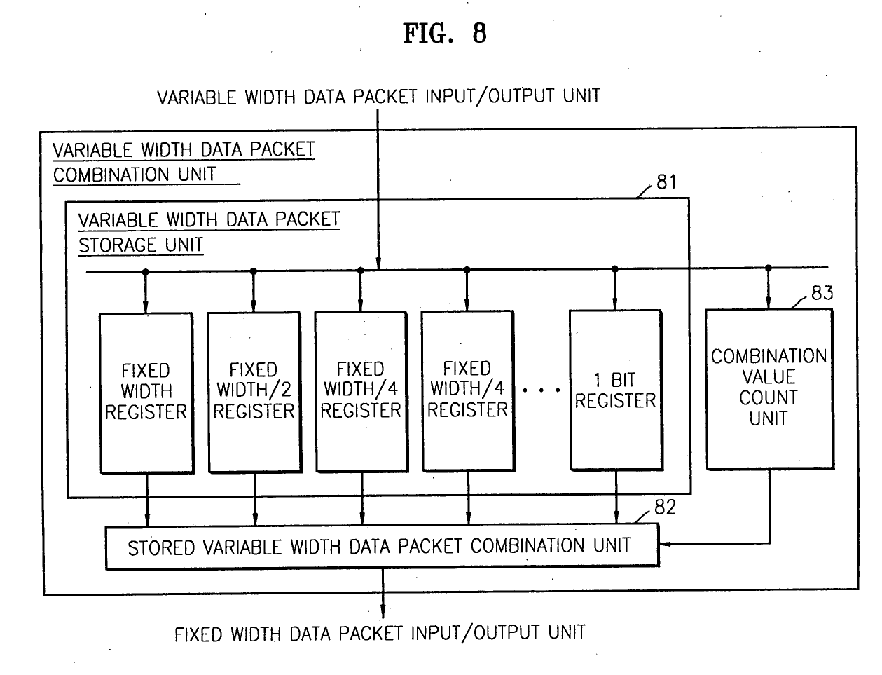

FIG. 8 is a diagram of a structure of the variable width data packet combination unit of FIG. 7.

The variable width data packet combination unit 72 comprises a variable width data packet storage unit 81, a stored variable width data packet combination unit 82, and a combination value count unit 83.

The variable width data packet storage unit 81 sequentially stores the same number of variable width first data packets as the combination value, the packets being input sequentially to the variable width data packet input/output unit 71. If the fixed width is a multiple of the variable width, for example, if the fixed width is 32 bits and the variable width is 16 bits, in order to generate a fixed width first data packet, two variable width data packets may be combined and for the combination of the two variable width data packets, two variable width data packets that are input in real time may be stored prior to the combination. Registers that are low capacity storage devices are generally used. Since a register provides only an entire reading/writing operation, a total of 32 registers may be used, including one 32-bit register, one 16-bit register, two 8-bit registers, four 4-bit registers, eight 2-bit registers, and 16 1-bit registers. Two 16-bit first data packets are stored in order of an input thereof, first in the 32-bit register and then in the 16-bit register. If the variable width is one bit, 32 1-bit first data packets are sequentially stored in the entire 32 registers.

The stored variable width data packet combination unit 82 combines the same number of variable width data packets as the combination value, the packets being sequentially stored in the variable width data packet storage unit 81, and generates a fixed width first data packet. The combination value count unit 83 counts a value obtained by subtracting 1 from the combination value, generates a combination signal whenever a value is counted, and outputs the generated combination signals. At this time, whenever the combination signal output from the combination value count unit 83 is received, the stored variable width data packet combination unit 82 sequentially combines the number of stored variable width first data packets, the number of which being the same as that of the combination value. For example, if the fixed width is 32 bits and the variable width is 16 bits, then the combination value is 2 and the combination value count unit 83 counts 1. Accordingly, a frequency of counting is 1 and the combination signal is output once. The stored variable width data packet combination unit 82 receives the combination signal once and at this time combines the stored 16-bit first data packets, and generates a 32-bit first data packet.

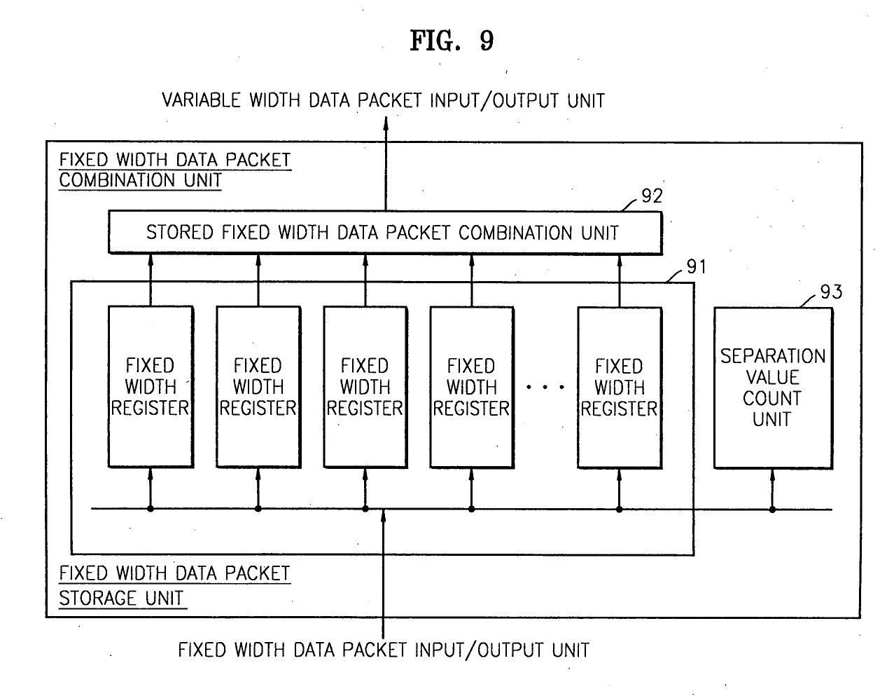

FIG. 9 is a diagram of a structure of the fixed width data packet combination unit of FIG. 7.

The fixed width data packet combination unit 75 comprises a fixed width data packet storage unit 91, a stored fixed width data packet combination unit 92 and a separation value count unit 93.

The fixed width data packet storage unit 91 sequentially stores the same number of fixed width second data packets as the separation value, the packets being sequentially input to the fixed width data packet input/output unit 76. If the fixed width is a multiple of the variable width, for example, if the variable width is 32 bits and the fixed width is 16 bits, to generate a variable width second data packet, two fixed width data packets may be combined and for the combination of the two fixed width data packets two variable width data packets that are input in real time may be stored prior to the combination. Since a register provides only an entire reading/writing operation, two 16-bit registers may be used. Two 16-bit first data packets are stored in two 16-bit registers in order of an input thereof. If the variable width is 64 bits, four 16-bit registers are needed. Accordingly, to satisfy an arbitrary external interface module, a proper number of fixed width registers may be disposed.

The stored fixed width data packet combination unit 92 combines fixed width second data packets sequentially stored in the fixed width data packet storage unit 91 and generates a variable width second data packet. The separation value count unit 93 counts a value obtained by subtracting one from the separation value, generates a combination signal whenever the value is counted, and outputs the generated combination signal. At this time, whenever the combination signal output from the separation value count unit 93 is received, the stored fixed width data packet combination unit 92 sequentially combines the number of stored variable width second data packets, the number of which being the same as that of the separation value. For example, if the variable width is 32 bits and the fixed width is 16 bits, then the separation value is 2 and the separation value count unit 93 counts 1. Accordingly, a frequency of counting is 1 and the separation signal is output once. The stored fixed width data packet combination unit 91 receives the separation signal once and at this time combines stored 16-bit second data packets, and generates a 32-bit second data packet.

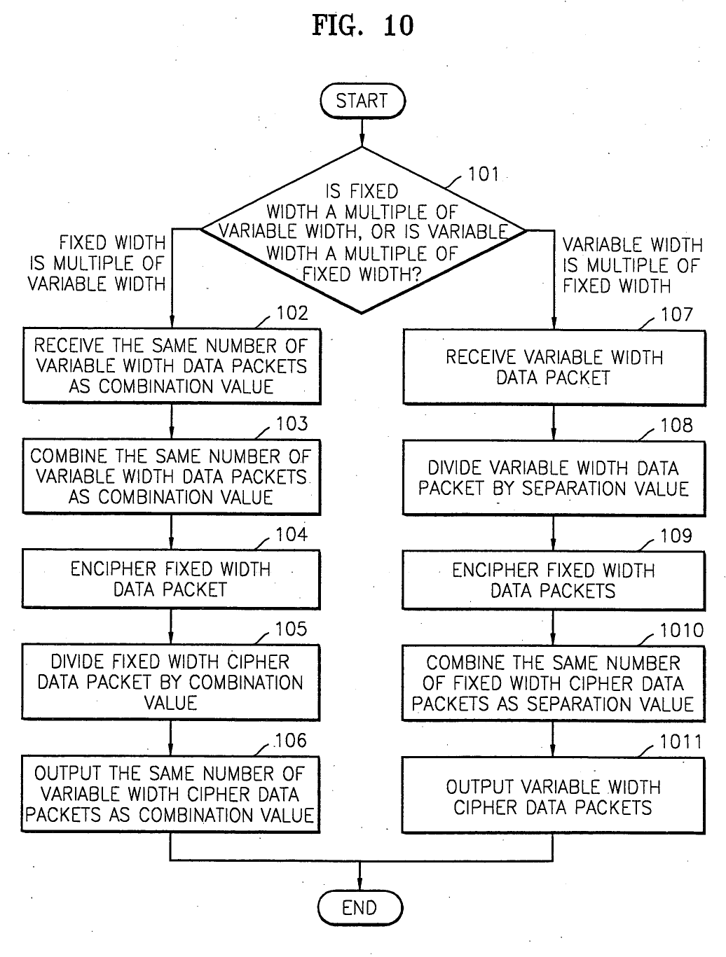

FIG. 10 is a flowchart of operations performed by a variable width data packet enciphering method according to a fifth embodiment of the present invention.

If a fixed width that is the width of a data packet is processed in an enciphering process and is a multiple of a variable width that is the width of an arbitrary data packet input from an arbitrary interface module in operation 101, a number of variable width data packets, the number of which being the same as that of a combination value, which is obtained by dividing a fixed width by a variable width are sequentially received in operation 102, and by combining the number of sequentially input variable width data packets received, a fixed width data packet is generated and output in operation 103. Further, by enciphering the output fixed width data packet, a fixed width cipher data packet is generated and output in operation 104. Further, by dividing the output fixed width cipher data packet into the number of variable width cipher data packets, the number of which being the same as that of a combination value, the number of divided variable width cipher data packets is generated in operation 105 and the number of generated variable width cipher data packets is sequentially output in operation 106.

If the variable width is a multiple of a fixed width in operation 101, a variable width data packet is input in operation 107, and by dividing the input variable width data packet into the number of fixed width data packets as that of a separation value that is obtained by dividing the variable width by the fixed width, the number of divided fixed width data packets is generated and sequentially output in operation 108. Further, by enciphering the number of the output fixed width data packets generated, the number of fixed width cipher data packets enciphered is generated and output in operation 109. Further, the number of fixed width cipher data packets generated is sequentially received and the number of sequentially input fixed width cipher data packets received is combined in operation 1010 and a variable width cipher data packet is generated and output in operation 1011.

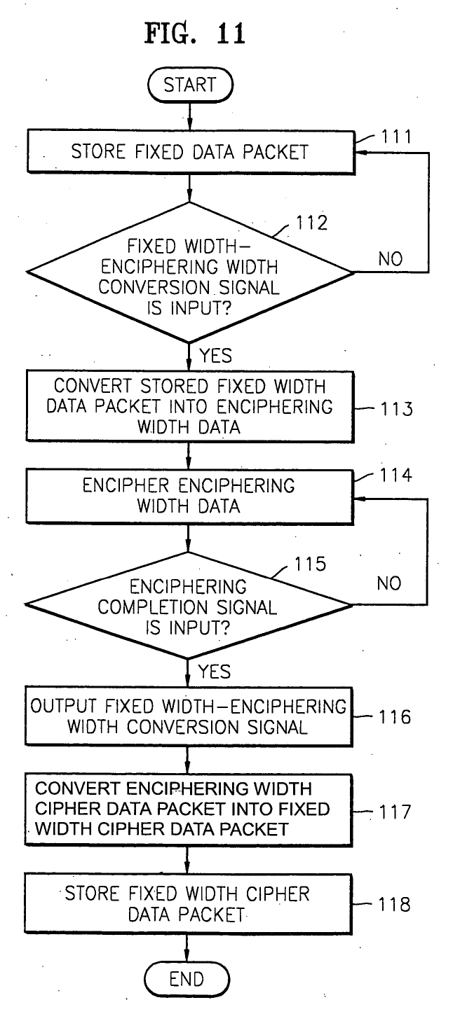

FIG. 11 is a flowchart of the operations 104 and 109 of FIG. 10.

A generated fixed width data packet is stored in operation 111. Further, if an output fixed width-enciphering width conversion signal is received in operation 112, the stored fixed width data packet is converted into enciphering width data in operation 113. By enciphering the converted enciphering width data, enciphering width cipher data is generated, and if the enciphering width cipher data is generated, an enciphering completion signal is generated and output in operation 114. If the output enciphering completion signal is received in operation 115, a fixed width-enciphering width conversion signal is generated and output in operation 116. Further, the generated enciphering width cipher data is converted into a fixed width cipher data packet in operation 117. Further, the converted fixed width cipher data packet is stored in operation 118.

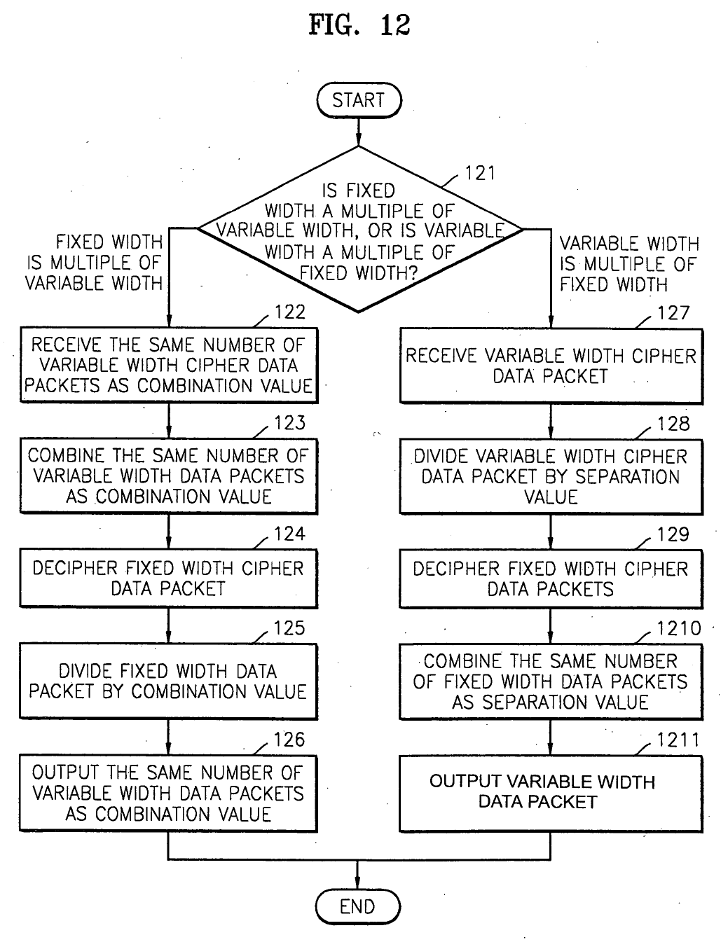

FIG. 12 is a flowchart of operations performed by a variable width cipher data packet deciphering method according to a sixth embodiment of the present invention.

If a fixed width that is the width of a cipher data packet to be processed in a deciphering process is a multiple of a variable width that is the width of an arbitrary cipher data packet input by an arbitrary interface module, in operation 121, the number of variable width cipher data packets, the number of which being the same as that of a combination value, which is obtained by dividing the fixed width by the variable width, is sequentially received in operation 122 and by combining the number of sequentially input variable width cipher data packets received, a fixed width cipher data packet is generated and output in operation 123. Further, by deciphering the output fixed width cipher data packet, a fixed width data packet is generated and output in operation 124. Further, by dividing outputted fixed width data packet into a number of variable width data packets, the number of which being the same as that of the combination value, the number of divided variable width data packets is generated in operation 125, and the number of generated variable width data packets is sequentially output in operation 126.

If the variable width is a multiple of the fixed width in operation 121, a variable width cipher data packet is received in operation 127, the input variable width cipher data packet is divided into the number of fixed width cipher packets, the number of which being the same as that of a separation value, that is obtained by dividing the variable width by the fixed width, and the number of divided fixed width cipher data packets is generated and sequentially output in operation 128. By deciphering the number of outputted fixed width cipher data packets, the number of fixed width data packets, the number of which being the same as that of the separation value, is generated and output in operation 129. Further, the number of outputted fixed width data packets is sequentially received, and the number of sequentially received fixed width cipher data packets is combined in operation 1210 and a variable width data packet is generated and output in operation 1211.

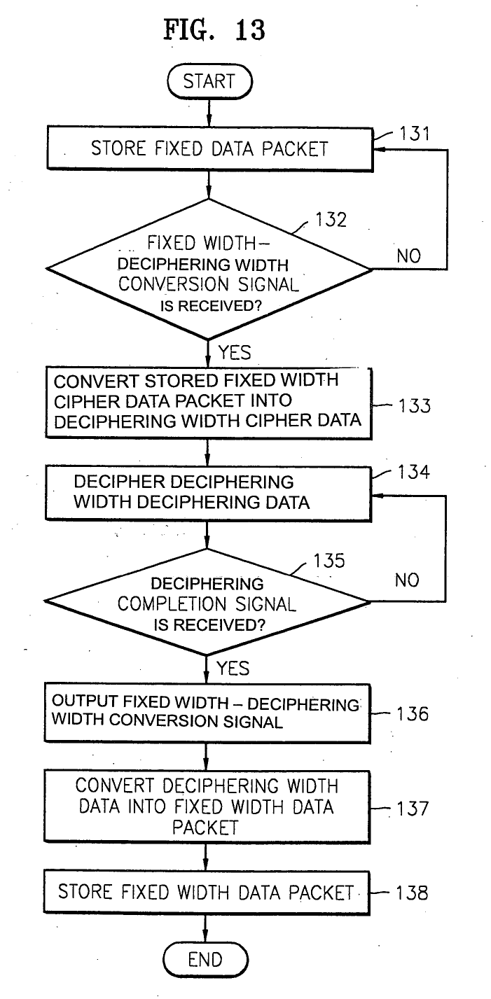

FIG. 13 is a flowchart of the operations 124 and 129 of FIG. 12.

A generated fixed width cipher data packet is stored in operation 131. Further, if an output fixed width-deciphering width conversion signal is received in operation 132, the stored fixed width cipher data packet is converted into deciphering width cipher data in operation 133. By deciphering the converted deciphering width cipher data, deciphering width data is generated and if the deciphering width data is generated, a deciphering completion signal is generated and output in operation 134. Further, if the output deciphering completion signal is received in operation 135, a fixed width-deciphering width conversion signal is generated and output in operation 136. The generated deciphering width data is converted into a fixed width data packet in operation 137. Further, the converted fixed width data packet is stored in operation 138.

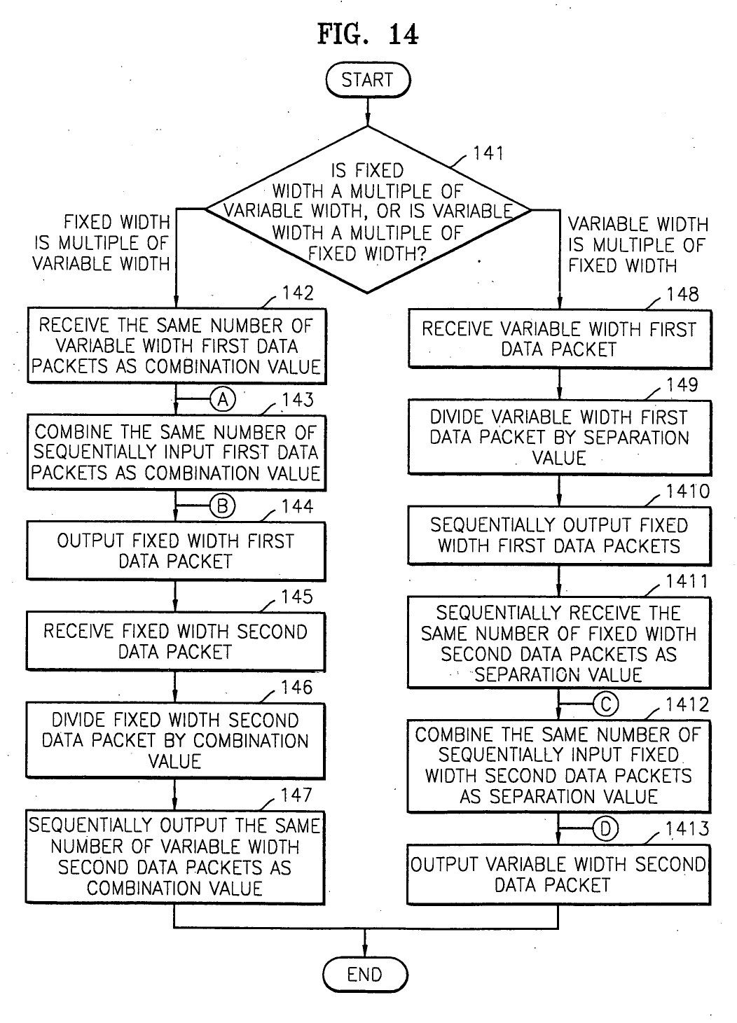

FIG. 14 is a flowchart of operations performed by a variable width-fixed width data packet conversion method according to a seventh embodiment of the present invention.

If a fixed width that is the width of a data packet processed inside the system is a multiple of a variable width that is the width of an arbitrary data packet input from the outside, in operation 141, the number of variable width first data packets, the number of which being the same as that of a combination value, that is obtained by dividing the fixed width by the variable width are sequentially received in operation 142. Further, by combining the number of sequentially input variable width first data packets received, a fixed width first data packet is generated in operation 143. The generated fixed width first data packet is output to an enciphering/deciphering module in operation 144. Further, a fixed width second data packet from this enciphering/deciphering module is received in operation 145. By dividing the received fixed width second data packet into a number of variable width second data packets, the number of which being the same as that of the combination value, the number of divided variable width second data packets is generated in operation 146. Further, the number of generated variable width second data packets is sequentially output in operation 147.

If the variable width is a multiple of the fixed width in operation 141, a variable width first data packet is received in operation 148. The received variable width first data packet is divided into a number of fixed width first data packets, the number of which being the same as that of a separation value, that is obtained by dividing the variable width by the fixed width, and the number of divided fixed width first data packets is generated in operation 149. The number of generated fixed width first data packets is sequentially output to the enciphering/deciphering module in operation 1410. Further, the number of fixed width second data packets from this enciphering/deciphering module, the number of which being the same as that of the separation value, which is obtained by dividing the variable width by the fixed width, are sequentially received in operation 1411. By combining the number of the sequentially received fixed width first data packets, a variable width second data packet is generated in operation 1412. Further, the generated variable width second data packet is output in operation 1413.

If the enciphering/deciphering module is an enciphering module, the second data packet will be a data packet enciphered from the first data packet, and if the enciphering/deciphering module is a deciphering module, the second data packet will be a data packet deciphered from the first data packet.

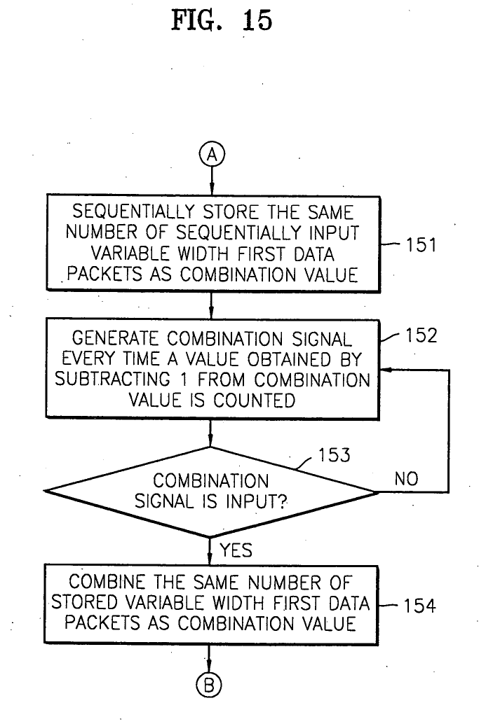

FIG. 15 is a flowchart of the operation 143 of FIG. 14.

The number of sequentially input variable width first data packets, the number of which being the same as that of the combination value, are sequentially stored in operation 151. Further, a value that is obtained by subtracting 1 from the combination value is counted and whenever the value is counted, a combination signal is generated and the generated combination signal is output in operation 152. Whenever the output combination signal is input in operation 153, the number of sequentially stored variable width first data packets is combined and a fixed width first data packet is generated in operation 154.

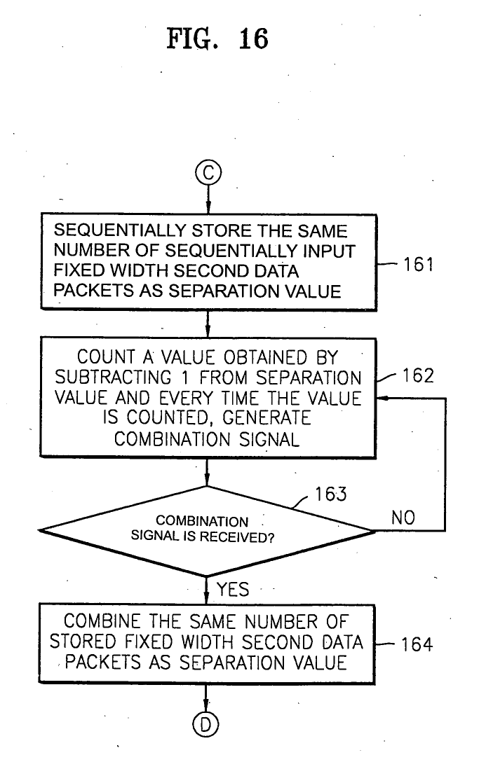

FIG. 16 is a flowchart of the operation 1412 of FIG. 14.

The number of sequentially input fixed width second data packets, the number of which being the same as that of the separation value, is sequentially stored in operation 161. Further, a value that is obtained by subtracting 1 from the separation value is counted and whenever the value is counted, a combination signal is generated and output in operation 162. Whenever the output combination signal is received in operation 163, the number of sequentially stored fixed width second data packets is sequentially combined and a variable width second data packet is generated in operation 164.

The present invention may be embodied in a code, which is readable by a computer, on a computer readable recording medium. The computer readable recording medium includes all kinds of recording apparatuses on which computer readable data are stored.

Also, the data structure used in the embodiments of the present invention can be recorded on a recording medium through a variety of data structures.

The computer readable recording media includes storage media such as magnetic storage media (e.g., ROM's, floppy disks, hard disks, etc.), optically readable media (e.g., CD-ROMs, DVDs, etc.) and carrier waves (e.g., transmissions over the Internet).

According to the present invention, when an external interface module connected to an IPsec chip is changed, data packets of variable widths output from an arbitrary external interface module are encipherable and variable width cipher data packets are decipherable. In particular, in an IPv6 environment, unlike in an IPv4 environment, the external interface module will be frequently changed due to characteristics of the IPv6 in order to use the IPsec apparatus in a variety of platforms (for example, all home appliances in a house). According to the present invention, when the IPsec chip is changed and/or redesigned, only an interface part over a memory controller needs to be redesigned such that the IPsec core including the memory controller does not need to be redesigned.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An apparatus for deciphering a variable width cipher data packet comprising:
a variable width-fixed width cipher data packet conversion unit which, if a fixed width is a width of a cipher data packet to be processed in a deciphering process and is a multiple of a variable width, which is a width of an arbitrary cipher data packet input by an arbitrary interface module, the variable width-fixed width cipher data packet conversion unit sequentially receives a number of variable width cipher data packets, the number of which being the same as that of a combination value, which is obtained by dividing the fixed width by the variable width, combines the number of sequentially input variable width cipher data packets received to generate a fixed width cipher data packet and outputs the fixed width cipher data packet; and
a deciphering unit which deciphers the fixed width cipher data packet output from the variable width-fixed width cipher data packet conversion unit to generate a fixed width data packet and outputs the fixed width data packet.

2. The apparatus of claim 1, wherein the variable width-fixed width cipher data packet conversion unit divides the fixed width data packet output from the deciphering unit into the number of variable width data packets, the number of which being the same as that of the combination value, to generate the number of variable width data packets, and sequentially outputs the number of the generated variable width data packets.

3. The apparatus of claim 1, wherein if the variable width is a multiple of the fixed width, the variable width-fixed width cipher data packet conversion unit receives the variable width cipher data packet, divides the received variable width cipher data packet into a number of fixed width cipher data packets, the number of which being the same as that of a separation value, that is obtained by dividing the variable width by the fixed width to generate the number of fixed width cipher data packets, and sequentially outputs the number of fixed width data packets generated, and the deciphering unit deciphers the number of fixed width cipher data packets output from the variable width-fixed width cipher data packet conversion unit to generate the number of fixed width data packets, the number of which being the same as that of the separation value, and outputs the number of fixed width data packets generated.

4. The apparatus of claim 3, wherein the variable width-fixed width cipher data packet conversion unit sequentially receives the number of fixed width data packets output from the deciphering unit, combines the number of fixed width data packet to generate a variable width data packet and outputs the variable width data packet.

5. The apparatus of claim 1, wherein the deciphering unit comprises:
a fixed width cipher data packet storage unit which stores the fixed width cipher data packet generated in the variable width-fixed width cipher data packet conversion unit;
a fixed width-deciphering width cipher data conversion unit which converts the fixed width cipher data packet stored in the fixed width cipher data packet storage unit into deciphering width cipher data;
a deciphering width cipher data deciphering unit which deciphers the deciphering width cipher data converted in the fixed width-deciphering width data conversion unit to generate deciphering width data;
a deciphering width-fixed width data packet conversion unit which converts the deciphering width data generated in the deciphering width cipher data deciphering unit into the fixed width data packet; and
a fixed width data packet storage unit which stores the fixed width data packet converted in the deciphering width-fixed width data packet conversion unit.

6. The apparatus of claim 5, wherein:
if the deciphering width data is generated, the deciphering width cipher data deciphering unit generates and outputs a deciphering completion signal;
the deciphering unit further comprises:
a deciphering control unit and if the deciphering completion signal output from the deciphering width cipher data deciphering unit is received, generates and outputs a fixed width-deciphering width conversion signal, and
if the fixed width-deciphering width conversion signal output from the deciphering control unit is received, the fixed width-deciphering width cipher data conversion unit converts the fixed width cipher data packet stored in the fixed width cipher data packet storage unit into the deciphering width cipher data.

7. A method of deciphering a variable width cipher data packet, comprising:
if a fixed width is a width of a cipher data packet to be processed in a deciphering process and is a multiple of a variable width, which is a width of an arbitrary cipher data packet input by an arbitrary interface module, sequentially receiving a number of variable width cipher data packets, the number of which being the same as that of a combination value, which is obtained by dividing the fixed width by the variable width, combining the number of sequentially input variable width cipher data packets, the number of which being the same as that of the combination value, to generate a fixed width cipher data packet and outputting the fixed width cipher data packet; and
deciphering the fixed width cipher data packet to generate a fixed width data packet and outputting the fixed width data packet.

8. The method of claim 7, further comprising:
dividing the fixed width data packet to generate the number of variable width data packets, the number of which being the same as that of the combination value, and sequentially outputting the number of the generated variable width data packets.

9. The method of claim 7, wherein in the generating and outputting of the fixed width cipher data packet, if the variable width is a multiple of the fixed width and the variable width cipher data packet is received, the received variable width cipher data packet is divided into a number of fixed width cipher data packets, the number of which being the same as that of a separation value, that is obtained by dividing the variable width by the fixed width to generate the number of divided fixed width cipher data packets and the number of fixed width cipher data packets generated is sequentially output, and
in the generating and outputting the fixed width data packet, the number of outputted fixed width cipher data packets is deciphered to generate the number of fixed width data packets, the number of which being the same as that of the separation value, and the number of generated fixed width data packets is output.

10. The method of claim 9, wherein in the generating and outputting of the fixed width cipher data packet, the number of outputted fixed width data packets, the number of which being the same as that of the separation value are sequentially received, the number of sequentially received fixed width data packet is combined to generate a variable width data packet and the variable width data packet is output.

11. The method of claim 7, wherein the generating and outputting the fixed width data packet comprises:
storing the fixed width cipher data packet,
converting the stored fixed width cipher data packet into deciphering width cipher data;
deciphering the converted deciphering width cipher data to generate a deciphering width data;
converting the deciphering width data into a fixed width data packet; and
storing the converted fixed width data packet.

12. The method of claim 11, wherein in the generating of the deciphering width data, if the deciphering width data is generated, generating and outputting a deciphering completion signal, the method further comprising:
generating and outputting a fixed width-deciphering width conversion signal if the deciphering completion signal output in the generating of the deciphering width data is received,
in the converting into deciphering width cipher data, if the fixed width-deciphering width conversion signal is received, converting the stored fixed width cipher data packet into deciphering width cipher data.

13. A variable width-fixed width data packet conversion method comprising:
if a fixed width that is the width of a data packet processed inside a system is a multiple of a variable width that is a width of an arbitrary data packet input from the outside of the system, sequentially receiving a number of variable width first data packets, the number of which being the same as that of a combination value, that is obtained by dividing the fixed width by the variable width;
combining the number of sequentially input variable width first data packets received to generate the fixed width first data packet; and
outputting the generated fixed width first data packet.

14. The method of claim 13, wherein the generating of the fixed width first data packet comprises:
sequentially storing the number of sequentially input variable width first data packets; and
by combining the number of sequentially stored variable width first data packets, generating the fixed width first data packet.

15. The method of claim 14, wherein the generating of the fixed width first data packet comprises:
counting a value obtained by subtracting 1 from the combination value;
generating a combination signal whenever the value is counted;
outputting the generated combination signals; and
in the generating of the fixed width first data packet, whenever a combination signal output from a combination value count unit is received, the number of stored variable width first data packets is sequentially combined.

16. The method of claim 13, further comprising:
if the variable width is a multiple of the fixed width, receiving a variable width first data packet;
dividing the received variable width first data packet into a number of fixed width first data packets, the number of which being the same as that of a separation value, that is obtained by dividing the variable width by the fixed width to generate the number of divided fixed width first data packets; and
sequentially outputting the number of generated fixed width first data packets.

17. The method of claim 13, further comprising:
sequentially receiving the number of fixed width second data packets, the number of which being the same as that of a separation value, that is obtained by dividing the variable width by the fixed width,
combining the number of sequentially received fixed width second data packets to generate the variable width second data packet; and
outputting the generated variable width second data packet.

18. The method of claim 17, wherein the generating of the variable width second data packet comprises:
sequentially storing the number of sequentially received fixed width second data packets; and
combining the sequentially stored fixed width second data packets to generate the variable width second data packet.
